(19) United States
(12) Patent Application Publication
(10) Pub. No.: US 2004/0066704 A1
(43) Pub. Date: Apr. 8, 2004

(54) Paint stirring device

(76) Inventor: Thomas K. Hong, Toronto (CA)

Correspondence Address: THOMAS K. HONG, 1666 QUEEN STREET EAST, UNIT 18, TORONTO, ON, M4L 1G3, CA

(21) Appl. No.: 10/667,844

(22) Filed: Sep. 23, 2003

Related U.S. Application Data
(60) Provisional application No. 60/417,909, filed on Oct. 7, 2002.

(51) Int. Cl. B01F 7/26

(52) U.S. Cl. 366/129; 366/316; 366/605

(57) ABSTRACT

A paint stirring device comprises an elongate handle having an attachment end and a free end and defining a main longitudinal axis, and a stirring member mounted on the elongate handle adjacent the attachment end thereof.

### FIELD OF THE INVENTION

The present invention relates to paint stirring devices, and more particularly to paint stirring devices that are easier to use and require less force to use than prior art paint stirring devices, and that more quickly and more thoroughly stir a can of paint than do prior art paint stirring devices.

### BACKGROUND OF THE INVENTION

The most common conventional paint stirring device is a wooden stick shaped to have a rounded handle portion that is easy to hold and a flat blade portion that engages the paint for stirring. Such conventional paint stir sticks are very inexpensive, and therefore are typically used as free promotional items when paint is purchased.

As it is well known, such conventional wooden paint stir sticks are somewhat difficult to use, and require a substantial force to grasp the paint stir stick and move it through the paint. Further, it takes longer than is desirable to stir paint as there is only a thin elongate blade passing through the paint. Also, it is common for paint to not get stirred thoroughly.

One very minor improvement to conventional wooden paint stir sticks is disclosed in U.S. Pat. No. 4,884,895 issued Dec. 5, 1989, to Rodgers, and entitled Paint Stirer. This Paint Stirer comprises an elongate body portion with a hand grip formed integrally at the top end thereof. A plurality of flexible and pliable members are fixedly secured to the bottom end of the elongate body portion to contact paint pigments that have settled out of colloidal suspension.

It is an object of the present invention to provide a paint stirring device that is easier to use than prior art paint stirring devices.

It is an object of the present invention to provide a paint stirring device that requires less force to use than prior art paint stirring devices.

It is an object of the present invention to provide a paint stirring device that can more quickly stir a can of paint than prior art paint stirring devices.

It is an object of the present invention to provide a paint stirring device that can more thoroughly stir a can of paint than prior art paint stirring devices.

### SUMMARY OF THE INVENTION

In accordance with one aspect of the present invention there is disclosed a novel paint stirring device comprising an elongate handle having an attachment end and a free end and defining a main longitudinal axis, and a stirring member mounted on the elongate handle adjacent the attachment end thereof.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the paint stirring device according to the present invention, as to its structure and use, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view of the paint stirring device according to the present invention;

FIG. 2 is an exploded perspective view of the paint stirring device of FIG. 1;

FIG. 3 is a perspective view of the paint stirring device of FIG. 1, with the stirring plate rotated to a storage angle;

FIG. 4 is a side elevational view of the handle of the paint stirring device of FIG. 1, taken along the face of the handle;

FIG. 5 is a second side elevational view of the handle of FIG. 4, taken along the side edge of the handle;

FIG. 6 is a cross-sectional view of the handle of FIG. 4, taken along section line 6-6 of FIG. 4;

FIG. 7 is a top plan view of the stirring plate of the paint stirring device of FIG. 1;

FIG. 8 is a first side elevational of the stirring plate of FIG. 7;

FIG. 9 is a second side elevational of the stirring plate of FIG. 7;

FIG. 10 is a perspective view of the paint stirring device of FIG. 1, in use in a paint can; and,

FIG. 11 is a perspective view similar to FIG. 10, but with the paint stirring device having moved vertically to stir the paint in a paint can.

### DETAILED DESCRIPTION OF A PREFERRED EMBODIMENT

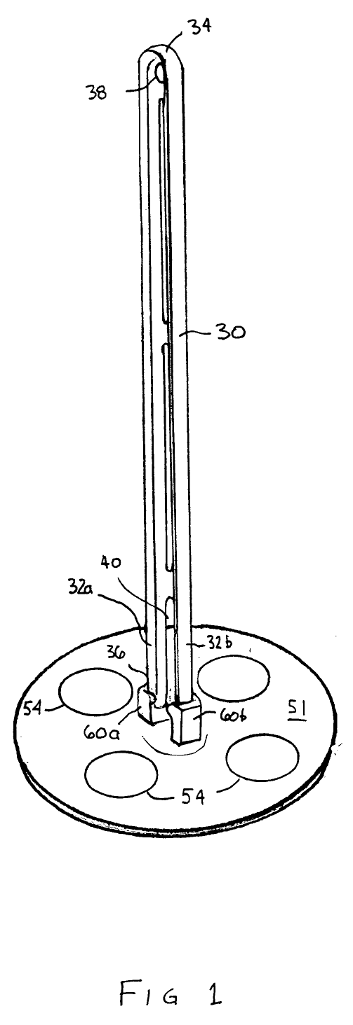

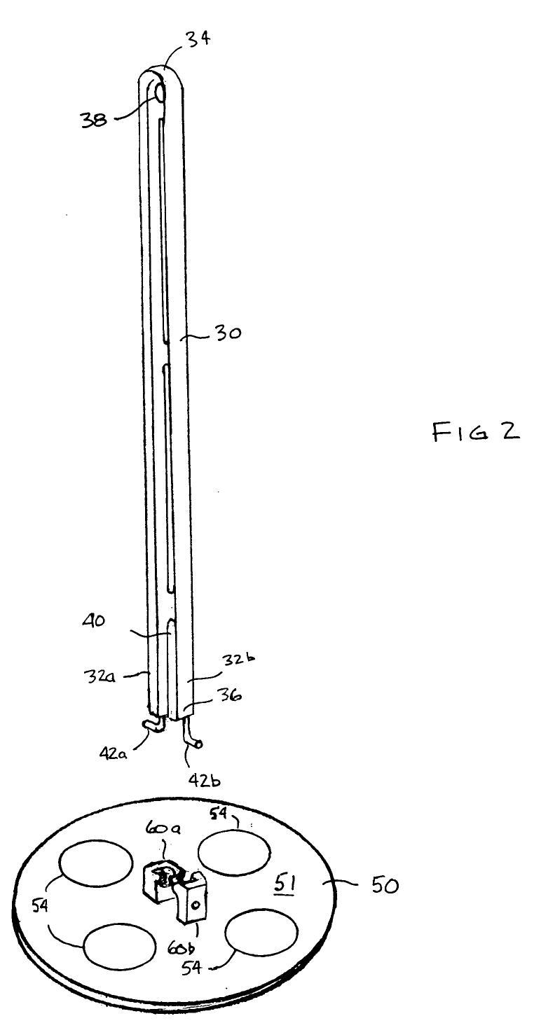

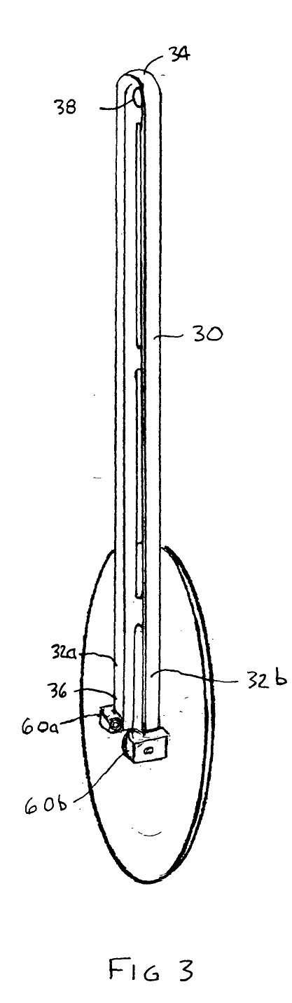

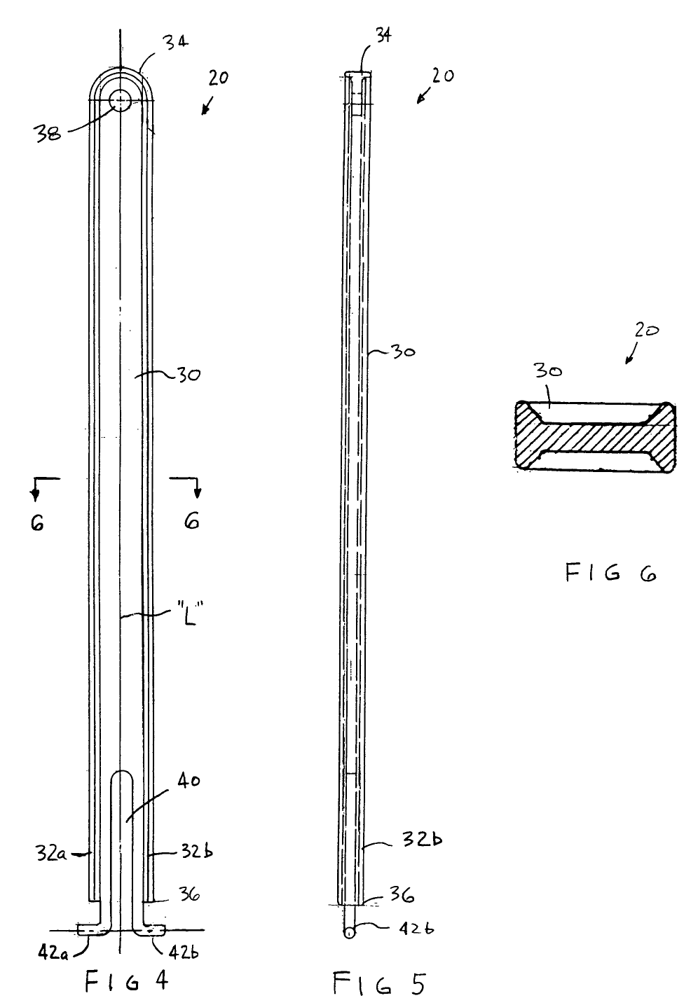

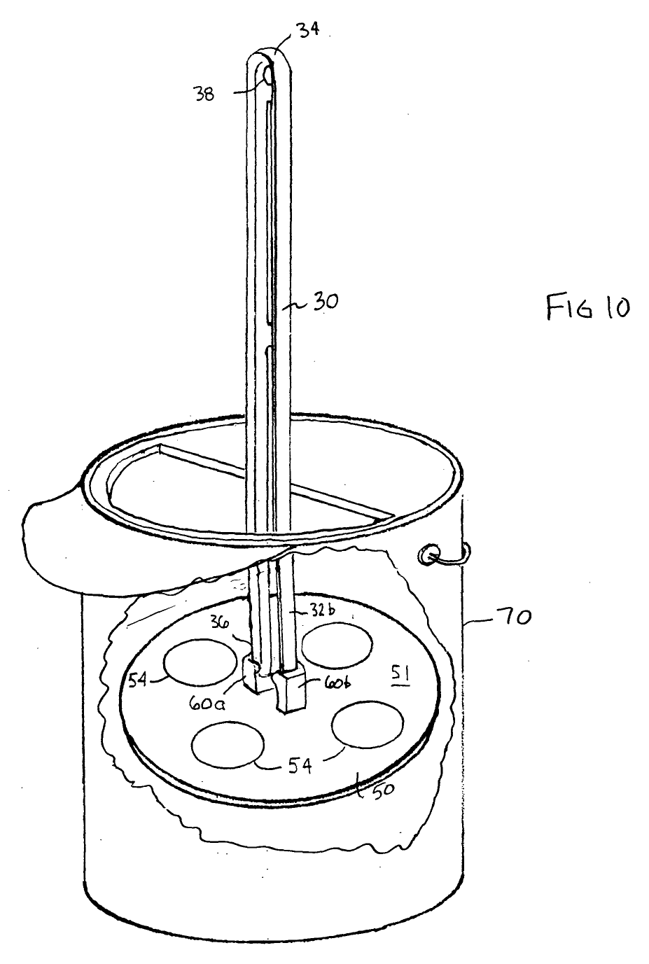

Reference will now be made to FIGS. 1 through 11, which show a preferred embodiment of the paint stirring device 20 according to the present invention. The paint stirring device 20 comprises two separate components, namely an elongate handle 30 and a stirring member in the form of a stirring plate 50.

The elongate handle 30, as is shown separately in FIGS. 4 through 6, defines a main longitudinal axis “L” and is preferably “I”-beam shaped in cross-section between an attachment end 36 and a free end 34, as best seen in FIG. 6. An aperture 38 is disposed adjacent the free end 34 for hanging up the paint stirring device 20. The attachment end 36 is bifurcated and terminates in a first leg 32a and a second leg 32b with a gap 40 between the legs 32a,32b. The gap 40 permits the legs 32a,32b to be pressed together slightly. The first and second legs 32a,32b terminate in an outwardly directed cylindrically shaped foot 42a,42b, respectively. The feet 42a,42b are oppositely directed one with respect to the other.

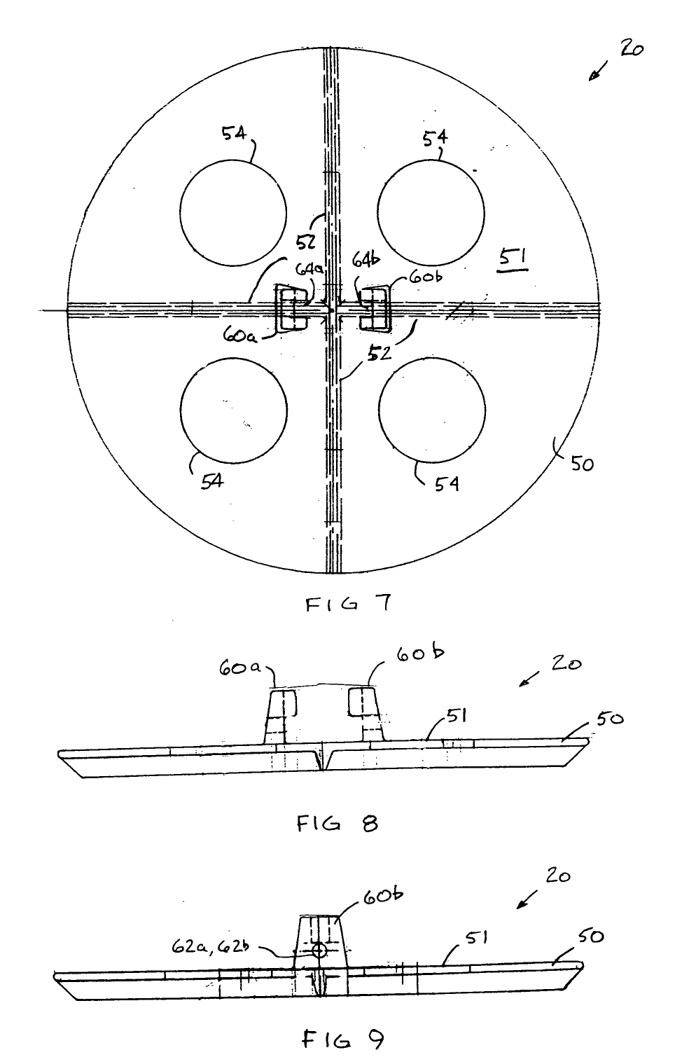

The stirring plate 50 is preferably substantially circular in shape, as is shown separately in FIGS. 7 through 9, is and about five inches in diameter and about one-quarter of an inch thick. Four transverse structural ribs 52 project outwardly from the center of the stirring plate 50 and provide structural integrity. At least one circular paint-passing aperture, and in the preferred embodiment illustrated four circular paint-passing apertures 54 are disposed in the stirring plate 50. The four paint-passing circular apertures 54 are radially evenly spaced around the center of the stirring plate 50, one between each of the four ribs 52. These four circular apertures 54 permit the passage of paint therethrough, so as cause thorough agitation of the paint.

First and second opposed mounting connector lugs 60a,60b project upwardly from the top surface 51 of the stirring plate 50. The connector lugs 60a,60b have a bore hole 62a,62b, respectively, therein. The two bore holes 62a,62b are aligned in axial relation one with the other, so as to receive the feet 42a,42b of the handle 30 therein, with the first foot 42a being received in the bore hole 62a in the first connector lug 60a and the second foot 42b being received in the bore hole 62b in the second connector lug 60b.

The first and second connector lugs 60a,60b have vertically disposed guide channels 64a,64b therein, respectively. The vertically disposed guide channels 64a,64b face each other so as to receive the legs 32a,32b of the handle 30 therein, one leg 32a,32b in each guide channel 64a,64b, when the handle 30 is in place. In this manner, the stirring plate 50 is removably mounted at its center onto the elongate handle 30 at the attachment end 36 of the handle 30.

In order to attach the handle 30 to the stirring plate 50 or to detach the handle 30 from the stirring plate 50, the first and second legs 32a,32b of the handle 30 are pressed together slightly such that the first and second legs 32a,32b and the two feet 42a,42b can pass between the gap 40 between the two connector lugs 60a,60b. Once the feet 42a,42b are each aligned with a corresponding bore hole 62a,62b, the legs 32a,32b can be released and each of the feet 42a,42b will enter the respective aligned bore hole 62a,62b. Further, if the handle 30 is disposed perpendicularly to the stirring plate 50, each of the legs 32a,32b will enter into a corresponding one of the vertically disposed guide channels 64a,64b in the connector lugs 60a,60b, thereby firmly maintaining the handle 30 in a perpendicular orientation with respect to the stirring plate 50.

Also, as is apparent, the stirring plate 50 is mounted in pivotal relation on the elongate handle 30 for pivotal movement about a pivot axis “P” oriented substantially transversely to the main longitudinal axis “L” of the handle 30, by means of the first outwardly directed cylindrically shaped foot 42a on the first leg 32a and the second outwardly directed cylindrically shaped foot 42b on the second leg 32b.

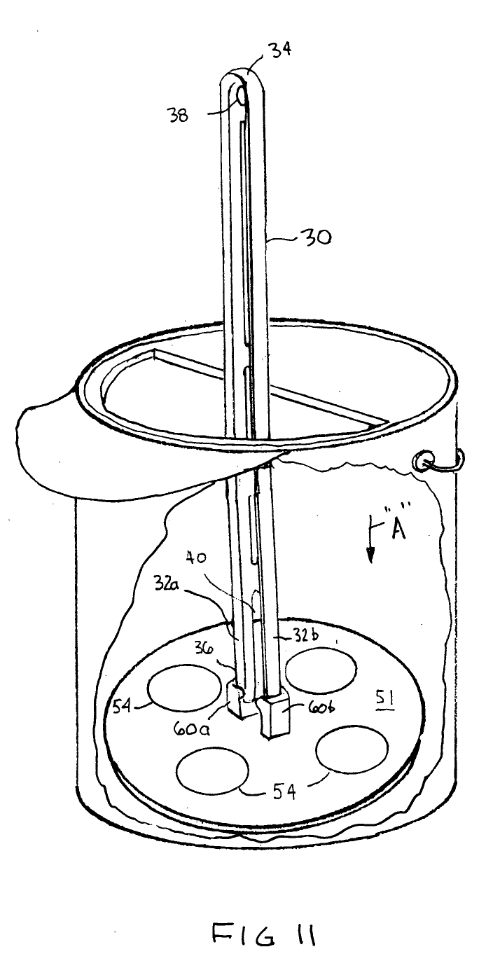

The handle 30 can also be oriented substantially parallel to the stirring plate 50, by pressing the legs 32a,32b together very slightly and pivoting the handle 30 with respect to the legs 32a,32b such that the feet 42a,42b pivot in the bore holes 62a,62b. In this orientation, the paint stirring device 20 is more compact for storage. Also, the stirring plate 50 can be passed through the opening of a paint can cover such as the one shown in FIGS. 10 and 11.

In use, in order to stir paint, the two legs 32a,32b of the handle 30 are received one in each of the two vertically disposed guide channels 64a,64b in the lugs of the stirring plate 50. In this manner, stirring plate 50 is firmly oriented transversely to the handle 30 and accordingly, when the handle 30 of the paint stirring device 20 is held and the stirring plate 50 is placed into a paint can, the stirring plate 50 is oriented horizontally so as to cover a substantial portion of the diametrical area of the interior of the paint can 70, as can be best seen in FIGS. 10 and 11. Thus, the stirring plate 50 is aligned for significant agitation of the paint when the paint stirring device 20 is an moved in an oscillating motion up and down by a user holding the handle 30, as indicated by arrow “A” in FIG. 11.

As can be understood from the above description and from the accompanying drawings, the present invention provides a paint stirring device that is easier to use than prior art paint stirring devices, that requires less force to use than prior art paint stirring devices that can more quickly stir a can of paint than prior art paint stirring devices, and that can more thoroughly stir a can of paint than prior art paint stirring devices, all of which features are unknown in the prior art.

Other variations of the above principles will be apparent to those who are knowledgeable in the field of the invention, and such variations are considered to be within the scope of the present invention. Further, other modifications and alterations may be used in the design and manufacture of the ???????? of the present invention without departing from the spirit and scope of the accompanying claims.

I claim:

1. A paint stirring device comprising:
an elongate handle having an attachment end and a free end and defining a main longitudinal axis; and,
a stirring member mounted on said elongate handle adjacent said attachment end thereof.

2. The paint stirring device of claim 1, wherein said stirring member comprises a stirring plate.

3. The paint stirring device of claim 2, wherein said stirring plate is mounted at the attachment end of said elongate handle.

4. The paint stirring device of claim 3, wherein said stirring plate is substantially circular in shape.

5. The paint stirring device of claim 4, wherein said stirring plate is mounted on said elongate handle at the centre of said stirring plate.

6. The paint stirring device of claim 5, wherein said stirring plate is mounted in pivotal relation on said elongate handle for pivotal movement about a pivot axis oriented substantially transversely to said main longitudinal axis of said handle.

7. The paint stirring device of claim 6, wherein said attachment end of said elongate is bifurcated and terminates in first and second legs, with a gap between the legs.

8. The paint stirring device of claim 7, wherein said stirring plate is mounted in pivotal relation on said elongate handle, as aforesaid, by means of a first outwardly directed cylindrically shaped foot on said first leg received within a bore hole of a first connector lug and a second outwardly directed cylindrically shaped foot on said second leg received within a bore hole of a second connector lug.

9. The paint stirring device of claim 4, further comprising at least one paint-passing aperture disposed in said stirring plate.

10. The paint stirring device of claim 9, wherein said at least one paint-passing aperture in said stirring plate comprises a plurality of paint-passing apertures disposed in said stirring plate.

11. The paint stirring device of claim 10, wherein said paint-passing apertures are substantially circular in shape.

12. The paint stirring device of claim 11, wherein said paint-passing apertures are radially evenly spaced around the center of said stirring plate.

13. The paint stirring device of claim 1, wherein said elongate handle is “I”-beam shaped in cross-section.

14. The paint stirring device of claim 1, further comprising an aperture disposed adjacent the free end of said elongate handle for hanging up said paint stirring device.
